(19) United States
(12) Patent Application Publication
(10) Pub. No.: US 2012/0230740 A1
(43) Pub. Date: Sep. 13, 2012

(54) INTERMEDIATE TRANSFER BELT AND IMAGE FORMING APPARATUS USING THE SAME

(75) Inventors: Yoshiharu MIKAMI, Miyagi (JP); Jun Aoto, Kanagawa (JP); Atsuo Hirai, Miyagi (JP); Shinichi Nitta, Miyagi (JP)

(73) Assignee: RICOH COMPANY, LTD., Tokyo (JP)

(21) Appl. No.: 13/415,013

(22) Filed: Mar. 8, 2012

(30) Foreign Application Priority Data
Mar. 11, 2011 (JP) 2011-054057

(51) Int. Cl. G03G 15/16

(52) U.S. Cl. 399/308

(57) ABSTRACT

An intermediate transfer belt including: a base layer; and an elastic layer, the elastic layer being laid on the base layer to form a laminated structure, wherein the elastic layer is an acrylic rubber-elastic layer with flame retardancy where the acrylic rubber-elastic layer has VTM-0 grade according to the UL94VTM burning test, wherein the elastic layer has a Martens hardness of 0.2 N/mm² to 0.8 N/mm² when indented to a depth of 10 μm, wherein the elastic layer has a uniform concavo-convex pattern in a surface thereof, and the uniform concavo-convex pattern is formed by arranging individual spherical resin particles in the surface of the elastic layer in a plane direction thereof, and wherein the intermediate transfer belt is configured to receive a toner image formed by developing, with a toner, a latent image on an image bearing member.

### BACKGROUND OF THE INVENTION

1. Field of the Invention

The present invention relates to a seamless belt which is mounted in image forming apparatuses such as copiers and printers, and an image forming apparatus using the seamless belt, in particular to an intermediate transfer belt which is suitable for full-color image formation, and an image forming apparatus using the intermediate transfer belt.

2. Description of the Related Art

Conventionally, in electrophotographic apparatuses, seamless belts have been used as members for various applications. Particularly, in full-color image forming apparatuses of recent years, an intermediate transfer belt system is used, in which development images of four colors: yellow, magenta, cyan, black, are superimposed on an intermediate transfer medium, and then the superimposed images are collectively transferred to a transfer medium, such as paper.

In such intermediate transfer belt system, with respect to one photoconductor four developing units are used, but use of such intermediate transfer belt system has a disadvantage that print speed is slow. For high speed printing, a four-series tandem system is used in which photoconductors for four colors are arranged in a tandem manner, and each color is continuously transferred on paper. However, in this system, it is difficult to achieve accurate registration upon superimposing respective images because of change of paper condition due to environment, causing out-of-color registration. Thus, recently, an intermediate transfer system has been predominately applied in the four-series tandem system.

For this reason, characteristics required for the intermediate transfer belt have been tough to achieve, such as high speed transfer, positional accuracy, but it is necessary to satisfy those characteristics. Particularly, it is demanded to inhibit variation in positional accuracy caused by deformation such as elongation of a belt itself due to continuous use. The intermediate transfer belt is required to be flame retardant, because it occupies a large area of an apparatus and a high voltage is applied thereto for transferring an image. In order to satisfy these demands, as an intermediate transfer belt material, a polyimide resin, and a polyamideimide resin, which have high elasticity and high heat resistance, are used.

However, an intermediate transfer belt made of a polyimide resin has high strength and thus high surface hardness. Therefore, in transferring a toner image, a high pressure is applied to the toner layer. As a result, the toner is locally aggregated, resulting in that part of the image is not transferred in some cases to form a so-called spot-containing image. Also, such an intermediate transfer belt has poor followability to, for example, a photoconductor, paper, which are brought into contact with the intermediate transfer belt at transfer positions. Such poor followability may cause insufficient contact portions (spaces) at the transfer positions, leading to uneven transfer.

In recent years, full-color electrophotographic image formation is often performed on various types of paper, such as commonly-used smooth paper, highly-smooth papers with slip properties (e.g., coated papers) and rough paper (e.g., recycled paper, embossed paper, Japanese paper and kraft paper). In the full-color electrophotographic image formation, followability to such papers that have various surface conditions is important. Poor followability causes unevenness in image density and color toner following irregularities of paper.

In order to solve this problem, various intermediate transfer belts have been proposed which contain a base layer and a relatively flexible rubber-elastic layer laminated on the base layer.

For example, Japanese Patent Application Laid-Open (JP-A) No. 2006-47609 discloses a transfer belt which includes a surface layer formed of fluorine-containing polymer, and an intermediate layer, as a rubber-elastic layer, which contains urethane, nitrile rubbers, silicone rubbers, polyamide, or combinations of two or more thereof. JP-A No. 10-83122 discloses a transfer belt which includes a surface layer formed of low-surface energy material including fluorine-based resins, and an intermediate layer, as a rubber-elastic layer, which contains fluorine-based rubbers or silicone rubbers. Additionally, JP-A No. 2010-15143 discloses an intermediate transfer belt in which following layers are successively laminated: a base; an elastic material layer containing from 50% by mass to 100% by mass of polyurethane elastomer; and a surface layer containing a curing agent and water-based urethane resin latex which contains, for example, fluorine resins and silicone components.

However, the above-mentioned intermediate transfer belts having the rubber-elastic layer and the surface layer have been unsatisfying due to insufficient image quality in paper having irregularities. Accordingly, the present inventors have proposed an intermediate transfer belt which includes a base layer, a resin layer containing a heat-curable elastomer or rubber material laminated on the base layer, and individual spherical resin particles embedded in the resin layer so that the embedment rate of the spherical resin particles in the depth direction of the resin layer is higher than 50% but lower than 100%, and which has a concavo-convex pattern formed by the spherical resin particles on the resin layer.

However, an intermediate transfer belt is often needed to have ozone resistance and flame retardancy resulted from halogen-free formulation as well as good followability to a surface of image receiving paper upon transfer operation.

### SUMMARY OF THE INVENTION

The present invention aims to solve the problem in the related art, and achieves a following object. The object of the present invention is to provide an intermediate transfer belt which has lower rubber hardness than conventional intermediate transfer belts, excellent transferability to high-ream weight paper having irregularities such as LEATHAC paper, as well as ozone resistance and flame retardancy, and an image forming apparatus using the intermediate transfer belt, in particular an image forming apparatus suitable for full-color image formation in which an intermediate transfer system is introduced.

Means for solving the above existing problems are as follows.

<1> An intermediate transfer belt including:

a base layer; and

an elastic layer,

the elastic layer being laid on the base layer to form a laminated structure,

wherein the elastic layer is an acrylic rubber-elastic layer with flame retardancy where the acrylic rubber-elastic layer has VTM-0 grade according to the UL94VTM burning test,

wherein the elastic layer has a Martens hardness of 0.2 N/mm² to 0.8 N/mm² when indented to a depth of 10 μm,

wherein the elastic layer has a uniform concavo-convex pattern in a surface thereof, and the uniform concavo-convex pattern is formed by arranging individual spherical resin particles in the surface of the elastic layer in a plane direction thereof, and

wherein the intermediate transfer belt is configured to receive a toner image formed by developing, with a toner, a latent image on an image bearing member.

<2> The intermediate transfer belt according to <1>, wherein the acrylic rubber-elastic layer with flame retardancy contains a metal hydroxide compound and a phosphorus compound.

<3> The intermediate transfer belt according to <1> or <2>, wherein the spherical resin particles are fine silicone resin particles.

<4> The intermediate transfer belt according to any one of <1> to <3>, wherein the spherical resin particles have a volume average particle diameter of 0.5 μm to 5 μm.

<5> The intermediate transfer belt according to any one of <1> to <4>, wherein the base layer contains at least one of a polyimide resin and a polyamideimide resin.

<6> An image forming apparatus including:

an image bearing member configured to form a latent image thereon and bear a toner image;

a developing unit configured to develop with a toner the latent image formed on the image bearing member to form the toner image;

an intermediate transfer belt onto which the toner image developed with the developing unit is primarily transferred; and

a transfer unit configured to secondarily transfer onto a recording medium the toner image transferred onto the intermediate transfer member;

wherein the intermediate transfer belt is the intermediate transfer belt according to any one of <1> to <5>.

<7> The image forming apparatus according to <6>, wherein the image forming apparatus is a full-color image forming apparatus where a plurality of the image bearing members each having the developing unit for each color are arranged in series.

The present inventors conducted extensive studies to obtain an intermediate transfer belt which has excellent image quality in paper having irregularities, and have found that an intermediate transfer belt has excellent image quality in paper having irregularities which includes a lamination structure having a base layer and an elastic layer successively laminated in this order from an inner side of the intermediate transfer belt, and in which the elastic layer has a Martens hardness of 0.2 N/mm² to 0.8 N/mm² when indented to a depth of 10 μm (at 10 μm-indentation depth). In addition, intermediate transfer belts are often demanded to have ozone resistance and flame retardancy. When an intermediate transfer belt contains sufficient amount of inorganic flame retardant agents such as fine spherical silicone resin particles, red phosphorus, aluminum hydroxide, and magnesium hydroxide, satisfying flame retardancy can be obtained, but problems may occur including deterioration of mechanical strength, especially toughness, increasing of hardness, and deterioration of elasticity (i.e., followability to paper). The present inventors also have found that an intermediate transfer belt can keep ozone resistance and low rubber hardness even though such inorganic flame retardant agents are contained to a certain degree. The present inventors also have found that acrylic rubbers are capable of imparting flame retardancy, and thus have been achieved the present invention. Accordingly, it will be understood from following detailed and specific description that an intermediate transfer belt of the present invention exhibits very excellent effects in that it achieves simultaneously both excellent image quality in paper having irregularities, and ozone resistance and flame retardancy.

### BRIEF DESCRIPTION OF THE DRAWINGS

FIG. 1 is an explanatory view of one layer structure of an intermediate transfer belt suitable for the present invention.

FIG. 2 schematically illustrates essential parts for explaining one exemplary image forming apparatus containing an intermediate transfer belt of the present invention.

FIG. 3 is an explanatory view of one digital color printer provided with four photoconductor drums for forming toner images of four colors, and a seamless belt of the present invention.

FIG. 4 illustrates one exemplary method for uniformly embedding a part of each fine spherical resin particle in a surface of an elastic layer in an intermediate transfer belt of the present invention.

FIG. 5 illustrates one exemplary apparatus for producing a base layer of a belt by means of a coating liquid for a base layer in the present invention.

### DETAILED DESCRIPTION OF THE INVENTION

An image forming apparatus uses seamless belts as several members. One seamless belt required for electrical characteristics is an intermediate transfer member (intermediate transfer belt).

Next, detail and specific description will be given to an intermediate transfer belt of the present invention and an image forming apparatus using the intermediate transfer belt.

The intermediate transfer belt of the present invention is suitably mounted to an image forming apparatus employing an intermediate transfer belt, in which a plurality of color toner-developed images are sequentially formed on image bearing members (e.g., photoconductor drums), and then primarily transferred onto and sequentially superposed on an intermediate transfer belt, and the resultant primarily-transferred image is secondarily transferred onto a recording medium at one time.

### (Intermediate Transfer Belt)

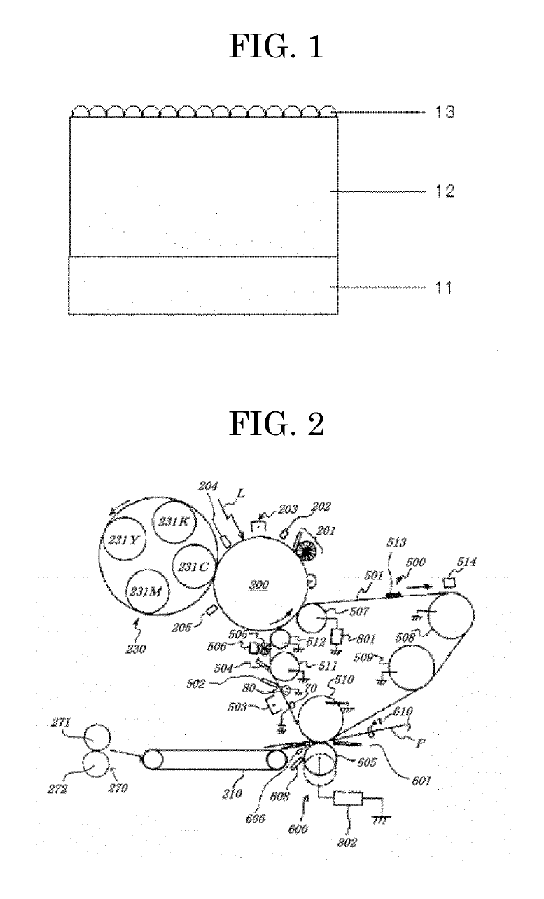

FIG. 1 illustrates a suitable layer structure of an intermediate transfer belt of the present invention.

This layer structure is composed of a relatively flexible, rigid base layer 11, a flexible elastic layer 12 laminated on the base layer, and fine particles as a particle layer 13 laminated on the uppermost surface.

### <Base Layer>

A base layer 11 will be described.

The material for the base layer is not particularly limited and may be appropriately selected depending on the intended purpose. Example thereof includes a resin containing a filler (or an additive) for adjusting electrical resistance, a so-called electrical resistance control agent.

The resin is not particularly limited and may be appropriately selected depending on the intended purpose, but preferable are fluorine resins such as PVDF and ETFE, polyimide resins, and polyamideimide resins in terms of flame retardancy; and polyimide resins and polyamideimide resins in terms of mechanical strength (high elasticity) and heat resistance.

The electrical resistance control agent is not particularly limited and may be appropriately selected depending on the intended purpose. Examples thereof include metal oxides, and carbon blacks; ion conductive agents; and conductive polymers. These may be used alone or in combination.

The metal oxide is not particularly limited and may be appropriately selected depending on the intended purpose. Examples thereof include zinc oxide, tin oxide, titanium oxide, zirconium oxide, aluminum oxide and silicon oxide. Further examples include products obtained by subjecting the above metal oxides to a surface treatment for improving dispersibility thereof.

The carbon black is not particularly limited and may be appropriately selected depending on the intended purpose. Examples thereof include ketjen black, furnace black, acetylene black, thermal black, and gas black.

The ion-conductive agent is not particularly limited and may be appropriately selected depending on the intended purpose. Examples thereof include tetraalkyl ammonium salts, trialkylbenzyl ammonium salts, alkylsulfonic acid salts, alkylbenzenesulfonic acid salts, alkylsulfates, glycerin fatty acid esters, sorbitan fatty acid esters, polyoxyethylenealkylamine, esters of polyoxyethylenealiphatic alcohols, alkylbetaine, and lithium perchlorate.

In a method for producing an intermediate transfer belt of the present invention a coating liquid containing at least a resin component may contain additives such as dispersing agent, reinforcing agent, lubricant, heat conduction agent, and antioxidant, if necessary.

When used in the seamless belt which is suitably mounted as the intermediate transfer belt, a resistance of the intermediate transfer belt is not particularly limited and may be appropriately selected depending on the intended purpose. For example, a carbon black is added in such an amount that the surface resistance is adjusted to 1×10⁸ Ω/square to 1×10¹⁴ Ω/square and the volume resistance is adjusted to 1×10⁷ Ω·cm to 1×10¹³ Ω·cm. The amount of the carbon black should be selected so that the formed film does not become brittle and easily cracked in terms of mechanical strength.

The intermediate transfer belt is not particularly limited and may be appropriately selected depending on the intended purpose, but preferably, the above resin (e.g., a polyimide or polyamideimide resin precursor) and the electrical resistance control agent are mixed together in an appropriate proportion to thereby prepare a coating liquid, which is then used to produce a seamless belt having well-balanced electrical characteristics (surface resistance and volume resistance) and mechanical strength.

The content of the electrical resistance control agent is not particularly limited and may be appropriately selected depending on the intended purpose. When the carbon black is used as the electrical resistance control agent, the content of the carbon black is preferably from 10% by mass to 25% by mass, more preferably from 15% by mass to 20% by mass, relative to the total solid content in the coating liquid. When a metal oxide is used as the electrical resistance control agent, the content of the metal oxide is preferably from 1% by mass to 50% by mass, more preferably from 10% by mass to 30% by mass, relative to the total solid content of the coating liquid. When the contents of the carbon black and the metal oxide are less than the lower limits of the above-mentioned ranges, the value of resistance can not be easily uniform and resistance against any potential varies with a wide range. When the contents of the carbon black and the metal oxide are more than the upper limits of the above-mentioned ranges, the intermediate transfer belt is degraded in terms of mechanical strength, which is not practically preferred.

A polyimide resin (hereinafter, also referred to as “polyimide”) or a polyamideimide resin (hereinafter, also referred to as “polyamideimide”), which are suitably used for materials of the base layer, will be specifically described.

### —Polyimide Resin—

The polyimide resin is not particularly limited and can be appropriately selected depending on the intended purpose. For example, aromatic polyimide resin is preferable.

The aromatic polyimide resin is obtained from polyamic acid (polyimide precursor), which is an intermediate product obtained by reacting a generally known aromatic polycarboxylic anhydride (or derivatives thereof) with aromatic diamine. Because of stiff main chain, the polyimide resin, particularly, aromatic polyimide resin is insoluble in a solvent and is not melted. Therefore, at first, aromatic polycarboxylic anhydride is reacted with aromatic diamine so as to synthesize a polyimide precursor (i.e., a polyamic acid or polyamide acid) which is soluble in an organic solvent. The thus prepared polyamic acid is molded by various methods, followed by dehydration/cyclization treatment (i.e., imidization) upon application of heat thereto or using a chemical method, so as to form polyimide. The outline of the reaction is represented by Reaction Scheme (1), which is an example of obtaining an aromatic polyimide.

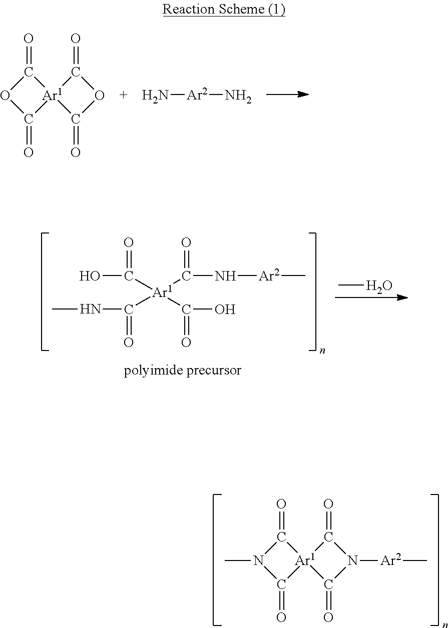

In Reaction Formula (1), Ar¹ denotes a tetravalent aromatic residue containing at least one six-membered carbon ring; and Are denotes a divalent aromatic residue containing at least one six-membered carbon ring.

### ——Aromatic Polycarboxylic Anhydride——

The aromatic polycarboxylic anhydride is not particularly limited and can be appropriately selected depending on the intended purpose. Examples thereof include pyromellitic dianhydride, 3,3′,4,4′-benzophenonetetracarboxylic dianhydride, 2,2′,3,3′-benzophenonetetracarboxylic dianhydride, 3,3′,4,4′-biphenyltetracarboxylic dianhydride, 2,2′,3,3′-biphenyltetracarboxylic dianhydride, 2,2-bis(2,3-dicarboxyphenyl)propane dianhydride, bis(3,4-dicarboxyphenyl)ether dianhydride, bis(3,4-dicarboxyphenyl)sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 2,2-bis(3,4-dicarboxyphenyl)-1,1,1,3,3,3-hexafluoropropane dianhydride, 2,3,6,7-naphthalenetetracarboxylic dianhydride, 1,4,5,8-naphthalenetetracarboxylic dianhydride, 1,2,5,6-naphthalenetetracarboxylic dianhydride, 1,2,3,4-benzenetetracarboxylic acid dianhydride, 3,4,9,10-perylenetetracarboxylic dianhydride, 2,3,6,7-anthracenetetracarboxylic dianhydride, and 1,2,7,8-phenanthrenetetracarboxylic dianhydride. Non-aromatic polycarboxylic anhydrides such as ethylenetetracarboxylic dianhydride and cyclopentanetetracarboxylic dianhydride can be used comparably with the aromatic polycarboxylic anhydrides. These may be used alone or in combination.

### ——Aromatic Diamine——

The aromatic diamine is not particularly limited and may be appropriately selected depending on the intended purpose. Examples thereof include m-phenylenediamine, o-phenylenediamine, p-phenylenediamine, m-aminobenzylamine, p-aminobenzylamine, 4,4′-diaminodiphenyl ether, 3,3′-diaminodiphenyl ether, 3,4′-diaminodiphenyl ether, bis(3-aminophenyl)sulfide, (3-aminophenyl)(4-aminophenyl)sulfide, bis(4-aminophenyl) sulfide, bis(3-aminophenyl) sulfide, (3-aminophenyl)(4-aminophenyl)sulfoxide, bis(3-aminophenyl)sulfone, (3-aminophenyl)(4-aminophenyl)sulfone, bis(4-aminophenyl)sulfone, 3,3′-diaminobenzophenone, 3,4′-diaminobenzophenone, 4,4′-diaminobenzophenone, 3,3′-diaminodiphenylmethane, 3,4′-diaminodiphenylmethane, 4,4′-diaminodiphenylmethane, bis[4-(3-aminophenoxy)phenyl]methane, bis[4-(4-aminophenoxy)phenyl]methane, 1,1-bis[4-(3-aminophenoxy)phenyl]ethane, 1,1-bis[4-(4-aminophenoxy)phenyl]ethane, 1,2-bis[4-(3-aminophenoxy)phenyl]ethane, 1,2-bis[4-(4-aminophenoxy)phenyl]ethane, 2,2-bis[4-(3-aminophenoxy)phenyl]propane, 2,2-bis[4-(4-aminophenoxy)phenyl]propane, 2,2-bis[4-(3-aminophenoxy)phenyl]butane, 2,2-bis[3-(3-aminophenoxy)phenyl]-1,1,1,3,3,3-hexafluoropropane, 2,2-bis[4-(4-aminophenoxy)phenyl]-1,1,1,3,3,3-hexafluoropropane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfoxide, bis[4-(4-aminophenoxy)phenyl]sulfoxide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 1,4-bis[4-(3-aminophenoxy)benzoyl]benzene, 1,3-bis[4-(3-aminophenoxy)benzoyl]benzene, 4,4′-bis[3-(4-aminophenoxy)benzoyl]diphenyl ether, 4,4′-bis[3-(3-aminophenoxy)benzoyl]diphenyl ether, 4,4′-bis[4-(4-amino-α,α-dimethylbenzyl)phenoxy]benzophenone, 4,4′-bis[4-(4-amino-α,α-dimethylbenzyl)phenoxy]diphenyl sulfone, bis[4-{-4-(4-aminophenoxy)phenoxy}phenyl]sulfone, 1,4-bis[4-(4-aminophenoxy)phenoxy]-α,α-dimethylbenzyl]benzene and 1,3-bis[4-(4-aminophenoxy)-α,α-dimethylbenzyl]benzene. These may be used alone or in combination.

Among these, at least 4,4′-diaminodiphenyl ether is preferably used as one of the components in order to effectively exhibit physical properties of the intermediate transfer member of the present invention.

A polyimide precursor (polyamic acid) is obtained in such a manner that a component of the aromatic polycarboxylic anhydride and a component of diamine are used approximately in an equimolar ratio, and subjected to polymerization reaction in an organic polar solvent. A method for producing a polyamic acid will be specifically described herein below.

An organic polar solvent, which is used in the polymerization reaction for obtaining polyamic acid is not particularly limited and may be appropriately selected depending on the intended purpose, as long as the solvent can solve the polyamic acid. Examples thereof include sulfoxide solvents such as dimethylsulfoxide and diethylsulfoxide, formamide solvents such as N,N-dimethylformamide and N,N-diethylformamide, acetamide solvents such as N,N-dimethylacetamide and N,N-diethylacetamide, pyrrolidone solvents such as N-methyl-2-pyrrolidone and N-vinyl-2-pyrrolidone; phenol solvents such as phenol, o-, m- or p-cresol, xylenol, halogenated phenol, catechol; ether solvents such as tetrahydrofuran, dioxane, dioxolan; alcohol solvents such as methanol, ethanol, butanol; cellosolve solvents such as butyl cellosolve; and hexamethylphosphoramide, γ-butyrolactone. These may be used alone or in combination. Among these, N,N-dimethylacetamide and N-methyl-2-pyrrolidone is preferably used.

One example of a method for preparing a polyimide precursor is as follows. At first, in an inert gas (such as argon gas and nitrogen gas) environment, one or more diamines are dissolved in an organic solvent, or may be dispersed in an organic solvent to form a slurry. When one or more aromatic polycarboxylic anhydrides or derivatives thereof are added in the resultant solution, in a form of solid, solution (in which the aromatic polycarboxylic anhydrides or derivatives thereof are dissolved in the organic solvent) or a slurry, a ring opening polymerization reaction accompanied with generation of heat is induced. In this case, the viscosity of the mixture rapidly increases, and a solution of polyamic acid having a high molecular mass is produced. In this case, the reaction temperature is preferably −20° C. to 100° C., and more preferably 60° C. or lower. The reaction time is preferably approximately 30 minutes to approximately 12 hours.

The addition order as described-above is one example, and is not limited thereto. Alternatively, firstly, aromatic polycarboxylic anhydride or derivative thereof is dissolved or dispersed in an organic solvent, and then the diamine may be added in the solution. The diamine may be added in a form of solid, solution (in which diamines are dissolved in the organic solvent) or slurry. That is, the addition order of an acid dianhydride component and a diamine component is not limited. In addition, the aromatic tetracarboxylic dianhydride and the aromatic diamine may be added at the same time to a polar organic solvent, so as to cause reaction.

As described above, the aromatic polycarboxylic anhydride or derivative thereof and the aromatic diamine component in an approximately equimolar ratio are polymerized in an organic polar solvent, so that a solution of a polyimide precursor in which the polyamic acid is uniformly dissolved in the polar organic solvent can be prepared.

As a polyimide precursor solution (i.e., a polyamic acid solution) used in the present invention, the polyimide precursor solution synthesized as described-above can be used. Alternatively, as a convenient way, commercially available polyamic acid composition dissolved in an organic solvent, or polyimide varnishes may be used.

The commercially available polyimide varnishes are not particularly limited and may be appropriately selected depending on the intended purpose. Specific examples thereof include TORENEES (manufactured by Toray Industries INC.), U-VARNISH (manufactured by Ube Industries, Ltd.), RIKA COAT (manufactured by New Japan Chemical Co., Ltd.), OPTOMER (manufactured by JSR Corporation), SE812 (manufactured by Nissan Chemical Industries, Ltd.), and CRC8000 (manufactured by Sumitomo Bakelite Co., Ltd.).

The thus synthesized or commercially available polyamic acid solution may be optionally mixed and dispersed with a filler to prepare a coating liquid. The coating liquid is applied to a support (or a mold) as described below, and the coated liquid is then subjected to a treatment such as heating. Thus, the polyamic acid (i.e., a polyimide precursor) is transformed into polyimide (i.e., imidization).

The method for imidizing polyamic acid is not particularly limited and may be appropriately selected depending on the intended purpose. Examples thereof include (1) a heating method or (2) a chemical method.

(1) The heating method is not particularly limited and may be appropriately selected depending on the intended purpose. For example, the polyamic acid is heated at a temperature of 200° C. to 350° C. to be transformed into polyimide. The heating method is a simple and useful method of obtaining polyimide (a polyimide resin).

(2) The chemical method is not particularly limited and may be appropriately selected depending on the intended purpose. For example, the polyamic acid is reacted with a dehydration ring forming agent such as mixtures of a carboxylic anhydride and tertiary amine, and then the reaction product is heated to complete imidization. Thus, (2) the chemical method is complicated compared to (1) the heating method and therefore the manufacturing costs are relatively high. Accordingly, (1) the heating method is popularly used.

In general, it is preferred that polyamic acid or the reaction product thereof be completely imidized by heating at a temperature equal to or higher than the glass transition temperature of a resultant polyimide, so as to exhibit the polyimide intrinsic properties.

The imidization ratio (i.e., the degree of a polyamic acid transformed into a polyimide) can be determined by any known methods which are used for measuring the imidization ratio. Examples thereof include a nuclear magnetic resonance (NMR) method in which the imidization ratio is determined on the basis of an integral ratio of ¹H of the amide group observed at 9 ppm to 11 ppm to ¹H of the aromatic group observed at 6 ppm to 9 ppm; a Fourier transfer infrared spectrophotometric method (i.e., FT-IR method); a method of determining water caused by an imide ring closure; and a method in which the amount of residual carboxylic acid is determined by a neutralization titration method. Of these methods, the Fourier transfer infrared spectrophotometric method (FT-IR method) is particularly commonly used.

When the FT-IR method is used, the imidization ratio is determined by the following equation (a). In the equation below, (A) represents the number of moles of the imide groups determined in the heating step (i.e., imidization step); and (B) represents the number of moles of the imide groups, when the polyamic acid is completely imidized (theoretically calculated).

Imidization ratio (%)=[(A)/(B)]×100 (a)

The number of moles of the imide groups in this definition can be determined by the absorbance ratio of the characteristic absorption of the imide group, measured by the FT-IR method. For example, as a typical characteristic absorption, the imidization ratio can be evaluated using the following absorbance ratio:

(1) A ratio of the absorbance of a peak at 725 cm⁻¹, which is specific to the imide, and caused by the bending vibration of the C═O group of the imide ring, to the absorbance of a peak at 1,015 cm⁻¹ which is specific to the benzene ring;

(2) A ratio of the absorbance of a peak at 1,380 cm⁻¹, which is specific to the imide, and caused by the bending vibration of the C—N group of the imide ring, to the absorbance of a peak at 1,500 cm⁻¹ which is specific to the benzene ring;

(3) A ratio of the absorbance of a peak at 1,720 cm⁻¹, which is specific to the imide, and caused by the bending vibration of the C═O group of the imide ring, to the absorbance of a peak at 1,500 cm⁻¹ which is specific to the benzene ring; and

(4) A ratio of the absorbance of a peak at 1,720 cm⁻¹, which is specific to the imide, to the absorbance of a peak at 1,670 cm⁻¹, which is specific to the amide group (the interaction of the bending vibration of the N—H group and the stretching vibration of the C—N group of the amide group).

Alternatively, when it is confirmed that the multiple absorption bands at 3,000 cm⁻¹ to 3,300 cm⁻¹, which are specific to the amide group, disappear, the reliability of completion of the imidization reaction is further enhanced.

### —Polyamideimide Resin—

Polyamideimide has both an imide group which is rigid and an amide group which can impart flexibility to a resin in a molecular skeleton thereof. Polyamideimide having known structures can be used in the present invention.

The general method for synthesizing polyamideimide is not particularly limited, and can be appropriately selected depending on the intended purpose. Examples thereof include (a) an acid chloride method, (b) an isocyanate method.

As (a) the acid chloride method, a method is known in which a halide compound derived from a trivalent carboxylic acid having an acid anhydride group (e.g., typically, an chloride compound of the derivative) is allowed to react with diamine in a solvent to thereby produce a polyamideimide resin (described in, for example, Japanese Patent Application Publication (JP-B) No. 42-15637).

As (b) the isocyanate method, a method is known in which a trivalent derivative having an acid anhydride group is allowed to react with a carboxylic acid and an aromatic polyisocyanate in a solvent to thereby produce a polyimideamide resin (see, for example, JP-B No. 44-19274).

Each production method will be described.

### (a) Acid Chloride Method

Examples of the derivative halide compounds of a trivalent carboxylic acid having an acid anhydride group include compounds represented by General Formula (2) or (3).

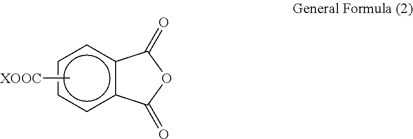

In General Formula (2), X represents a halogen atom.

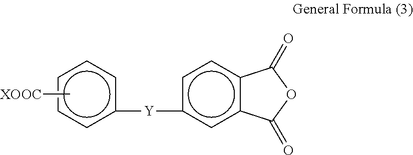

In General Formula (3), X represents a halogen atom, Y represents —CH₂—, —CO—, —SO₂— or —O—.

In each formula above, the halogen element is not particularly limited and may be appropriately selected depending on the intended purpose, but chlorine is preferable. Examples of derivatives thereof include an acid chloride of a polycarboxylic acid such as terephthalic acid chloride, isophthalic acid chloride, 4,4′-biphenyldicarboxylic acid chloride, 4,4′-biphenyletherdicarboxyulic acid chloride, 4,4′-biphenylsulfonedicarboxylic acid chloride, 4,4′-benzophenonedicarboxylic acid chloride, pyromellitic acid chloride, trimellitic acid chloride, 3,3′,4,4′-benzophenonetetracarboxylic acid chloride, 3,3′,4,4′-biphenylsulfonetetracarboxylic acid chloride, 3,3′,4,4′-biphenyltetracarboxylic acid chloride, adipic acid chloride, sebacic acid chloride, maleic acid chloride, fumaric acid chloride, dimer acid chloride, stilbenedicarboxylic acid chloride, 1,4-cyclohexanedicarboxylic acid chloride and 1,2-cyclohexanedicarboxylic acid chloride.

The diamine is not particularly limited and may be appropriately selected depending on the intended purpose. Examples thereof include aromatic diamines, aliphatic diamines, and alicyclic diamines. Of these, aromatic diamines are preferred.

The aromatic diamine is not particularly limited and may be appropriately selected depending on the intended purpose. Examples thereof include m-phenylenediamine, p-phenylenediamine, oxydianiline, methylenediamine, hexafluoroisopropylidene diamine, diamino-m-xylylene, diamino-p-xylylene, 1,4-napthalenediamine, 1,5-napthalenediamine, 2,6-napthalenediamine, 2,7-napthalenediamine, 2,2′-bis-(4-aminophenyl)propane, 2,2′-bis-(4-aminophenyl)hexafluoropropane, 4,4′-diaminodiphenyl sulfone, 4,4′-diaminodiphenyl ether, 3,3′-diaminodiphenyl sulfone, 3,3′-diaminodiphenyl ether, 3,4-diaminobiphenyl, 4,4′-diaminobenzophenone, 3,4-diaminodiphenyl ether, isopropylidenedianiline, 3,3′-diaminobenzophenone, o-tolidine, 2,4-tolylenediamine, 1,3-bis-(3-aminophenoxy)benzene, 1,4-bis-(4-aminophenoxy)benzene, 1,3-bis-(4-aminophenoxy)benzene, 2,2-bis-[4-(4-aminophenoxy)phenyl]propane, bis-[4-(4-aminophenoxy)phenyl]sulfone, bis-[4-(3-aminophenoxy)phenyl]sulfone, 4,4′-bis-(4-aminophenoxy)biphenyl, 2,2′-bis-[4-(4-aminophenoxy)phenyl]hexafluoropropane, 4,4′-diaminodiphenyl sulfide and 3,3′-diaminodiphenyl sulfide.

The siloxane compound having amino groups at both ends thereof is not particularly limited and may be appropriately selected depending on the intended purpose. Examples thereof include 1,3-bis(3-aminopropyl)-1,1,3,3-tetramethyldisiloxane, α,ω-bis(3-aminopropyl)polydimethylsiloxane, 1,3-bis(3-aminophenoxymethyl)-1,1,3,3-tetramethyldisiloxane, α,ω-bis(3-aminophenoxymethyl)polydimethylsiloxane, 1,3-bis(2-(3-aminophenoxy)ethyl)-1,1,3,3-tetramethyldisiloxane, α,ω-bis(2-(3-aminophenoxy)ethyl)polydimethylsiloxane, 1,3-bis(3-(3-aminophenoxy)propyl)-1,1,3,3-tetramethyldisiloxane and α,ω-bis(3-(3-aminophenoxy)propyl)polydimethylsiloxane. By using the siloxane compound as diamine, a silicone-modified polyamideimide resin can be prepared.

In order to obtain polyamideimide (polyamideimide resin) by the acid chloride method, in the same manner as in the production of the polyimide resin, the derivative halide of the trivalent carboxylic acid having an acid anhydride group and the diamine are dissolved in an organic polar solvent, and then reacted at a low temperature (0° C. to 30° C.) to form a polyamideimide resin precursor (polyamide-amic acid).

The organic polar solvent is not particularly limited as long as it solves polyamic acid, may be appropriately selected depending on the intended purpose, and the same organic polar solvents as those used in the polyimide can be used. Examples thereof include formamide solvents (e.g., sulfoxide solvents such as dimethyl sulfoxide and diethyl sulfoxide, N,N-dimethyl formamide, N,N-diethyl formamide), acetamide solvents (e.g., N,N-dimethyl acetamide, N,N-diethyl acetamide), pyrrolidone solvents (e.g., N-methyl-2-pyrrolidone, N-vinyl-2-pyrrolidone), phenol solvents (e.g., phenol, o-, m-, or p-cresol, xylenol, phenol halide, catechol), ether solvents (e.g., tetrahydrofuran, dioxane, dioxolan), alcohol solvents (e.g., methanol, ethanol, butanol), cellosolve solvents (e.g., butyl cellosolve), and hexamethylphosphoramide, and γ-butyrolactone. These may be used alone or in combination. Of these, N,N-dimethyl acetamide, and N-methyl-2-pyrrolidone are preferable.

The polyamide/polyamic acid solution is applied to a support (or a mold), and the coated liquid is then subjected to a treatment such as heating. Thus, the polyamic acid is transformed into polyimide (i.e., imidization).

The imidization method is not particularly limited and may be appropriately selected depending on the intended purpose. Examples thereof include a method in which dehydration ring closing is performed through thermally treating and a method in which dehydration ring closing is performed through chemically treating.

In the case where dehydration ring closing is performed through thermally treating, the reaction temperature is not particularly limited and may be appropriately selected depending on the intended purpose. It is preferably 150° C. to 400° C., particularly preferably 180° C. to 350° C. The thermally treating time is not particularly limited and may be appropriately selected depending on the intended purpose. It is preferably 30 sec to 10 hours, particularly preferably 5 min to 5 hours.

In the case where chemically ring closing is performed using the catalyst for dehydration ring closing, the reaction temperature is not particularly limited and may be appropriately selected depending on the intended purpose. It is preferably 0° C. to 180° C., particularly preferably 10° C. to 80° C. The reaction time is not particularly limited and may be appropriately selected depending on the intended purpose. It is preferably several tens minutes to several days, particularly preferably 2 hours to 12 hours. The catalyst for dehydration ring closing is not particularly limited and may be appropriately selected depending on the intended purpose. Examples thereof include acid anhydrides of acetic acid, propionic acid, butylic acid, benzoic acid.

### (b) Isocyanate Method

Examples of the derivative of the trivalent carboxylic acid compound having an acid anhydride group in the isocyanate method include compounds represented by General Formula (4) or (5).

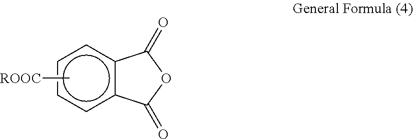

In General Formula (4), R denotes a hydrogen atom, an alkyl or phenyl group having 1 to 10 carbon atoms.

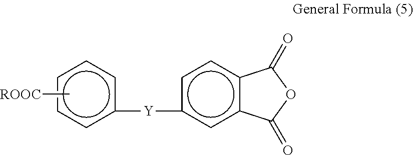

In General Formula (5), R denotes a hydrogen atom, an alkyl or phenyl group having 1 to 10 carbon atoms; Y denotes —CH₂—, —CO—, —SO₂— or —O—.

Any derivatives represented by General Formula (4) or (5) can be used, and trimellitic anhydride is typically used. The derivatives of the trivalent carboxylic acid compound having an acid anhydride group may be used alone or in combination depending on the intended purpose.

The aromatic polyisocyanate used in a synthesis of the polyamideimide resin is not particularly limited and may be appropriately selected depending on the intended purpose. Examples thereof include 4,4′-diphenylmethane diisocyanate, tolylene diisocyanate, xylylene diisocyanate, 4,4′-diphenylether diisocyanate, 4,4′-[2,2-bis(4-phenoxyphenyl)propane]diisocyanate, biphenyl-4,4′-diisocyanate, biphenyl-3,3′-diisocyanate, biphenyl-3,4′-diisocyanate, 3,3′-dimethylbiphenyl-4,4′-diisocyanate, 2,2′-dimethylbiphenyl-4,4′-diisocyanate, 3,3′-diethylbiphenyl-4,4′-diisocyanate, 2,2′-diethylbiphenyl-4,4′-diisocyanate, 3,3′-dimethoxybiphenyl-4,4′-diisocyanate, 2,2′-dimethoxybiphenyl-4,4′-diisocyanate, naphthalene-1,5-diisocyanate and naphthalene-2,6-diisocyanate. These may be used alone or in combination.

The aromatic polyisocyanate is not particularly limited and may be appropriately selected depending on the intended purpose. The following may be used if necessary: aliphatic, alicyclic isocyanates such as hexamethylene diisocyanate, 2,2,4-trimethylhexamethylene diisocyanate, isophorone diisocyanate, 4,4′-dicyclohexylmethane diisocyanate, transcyclohexane-1,4-diisocyanate, hydrogenated m-xylene diisocyanate and lysine diisocyanate, and tri- or higher functional polyisocyanates.

A solution containing a polyamideimide precursor prepared by dissolving the derivative of the trivalent carboxylic acid compound having an acid anhydride group and the aromatic polyisocyanate in an organic polar solvent is applied to a support (or a mold), and then the coated liquid is heated, so as to transform the polyamideimide precursor into polyamideimide. When the polyamideimide precursor is transformed into polyamideimide by the isocyanate method, carbon dioxide is generated to form polyamideimide without forming an intermediate product such as polyamic acid. Formula (6) represents an example of polyamideimidization by using trimellitic anhydride and aromatic diisocyanate.

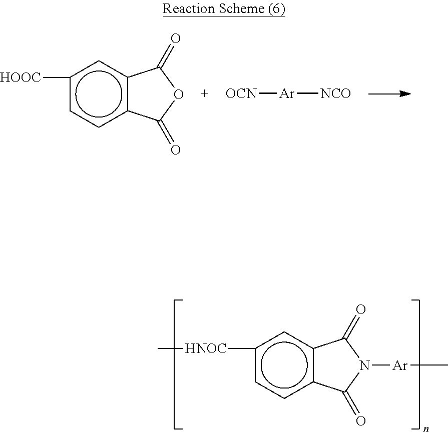

In Reaction Scheme (6), Ar denotes an aromatic group.

The polyimide and polyamideimide shown above usually used alone, but may be used in combination of two or more appropriately selected considering compatibility therebetween. Also, the resin may be a copolymer having a polyimide repeating unit and a polyamideimide repeating unit.

### <Elastic Layer>

Next, the elastic layer will be described.

The elastic layer is laid over the base layer.

The elastic layer is not particularly limited and may be appropriately selected depending on the intended purpose provided that the elastic layer contains acrylic rubber with flame retardancy (i.e., the elastic layer is an acrylic rubber-elastic layer with flame retardancy).

The acrylic rubber is not particularly limited and may be appropriately selected depending on the intended purpose. For example, those which are commercially available at present may be used.

A crosslinking system of the acrylic rubber is not particularly limited and may be appropriately selected depending on the intended purpose. Examples thereof include epoxy group crosslinking system, active chlorine group crosslinking system, and carboxyl group crosslinking system. Among these, the carboxyl group crosslinking system is preferable in that it exhibits excellent physical properties (in particular, compression set) and processability of rubber.

A crosslinking agent for the acrylic rubber crosslinked with the carboxyl group crosslinking system is not particularly limited and may be appropriately selected depending on the intended purpose, but it is preferably amine compounds, more preferably polyamine compounds.

The amine compounds are not particularly limited and may be appropriately selected depending on the intended purpose. Examples thereof include aliphatic polyamine crosslinking agents and aromatic polyamine crosslinking agents.

The aliphatic polyamine crosslinking agent is not particularly limited and may be appropriately selected depending on the intended purpose. Examples thereof include hexamethylenediamine, hexamethylenediamine carbamate, and N,N-dicinnamylidene-1,6-hexanediamine.

The aromatic polyamine crosslinking agents are not particularly limited and may be appropriately selected depending on the intended purpose. Examples thereof include 4,4′-methylenedianiline, m-phenylenediamine, 4,4′-diaminodiphenyl ether, 3,4′-diaminodiphenyl ether, 4,4′-(m-phenylenediisopropylidene)dianiline, 4,4′-(p-phenylenediisopropylidene)dianiline, 2,2′-bis[4-(4-aminophenoxy)phenyl]propane, 4,4′-diaminobenzanilide, 4,4′-bis(4-amimnophenoxy)biphenyl, m-xylylenediamine, p-xylylenediamine, 1,3,5-benzenetriamine, and 1,3,5-benzenetriaminomethyl.

The content of the crosslinking agent is not particularly limited and may be appropriately selected depending on the intended purpose, it is preferably from 0.05 parts by mass to 20 parts by mass, more preferably 0.1 parts by mass to 5 parts by mass, based on 100 parts by mass of the acrylic rubber. When the content of the crosslinking agent is too small, the degree of crosslinking is insufficient for a crosslinked product to keep a desired shape. In contrast, when the crosslinking agent is too large, a crosslinked product is too hard to have good rubber elasticity.

The elastic layer may further include a crosslinking accelerator in combination with the crosslinking agent. The crosslinking accelerator is not particularly limited and may be appropriately selected depending on the intended purpose, but it is preferably a crosslinking accelerator which can be used in combination with the polyamine crosslinking agent. Examples of such crosslinking accelerator include guanidine compounds, imidazole compounds, quaternary onium salts, polyvalent tertiary amine compounds, tertiary phosphine compounds and alkali metal salts of weak acids.

The guanidine compounds are not particularly limited and may be appropriately selected depending on the intended purpose. Examples thereof include 1,3-diphenylguanidine and 1,3-diorthotolylguanidine.

The imidazole compounds are not particularly limited and may be appropriately selected depending on the intended purpose. Examples thereof include 2-methylimidazole and 2-phenylimidazole.

The quaternary onium salts are not particularly limited and may be appropriately selected depending on the intended purpose. Examples thereof include tetra-n-butylammonium bromide and octadecyltri-n-butylammonium bromide.

The polyvalent tertiary amine compounds are not particularly limited and may be appropriately selected depending on the intended purpose. Examples thereof include triethylenediamine and 1,8-diaza-bicyclo-[5.4.0]undecene-7 (DBU).

The tertiary phosphine compounds are not particularly limited and may be appropriately selected depending on the intended purpose. Examples thereof include triphenylphosphine and tri-p-tolylphosphine.

The alkali metal salts of weak acids are not particularly limited and may be appropriately selected depending on the intended purpose. Examples thereof include sodium salts or potassium salts of weak inorganic acids such as phosphoric acid and carbonic acid, or of weak organic acids such as stearic acid and lauric acid.

The amount of the crosslinking accelerator used is not particularly limited and may be appropriately selected depending on the intended purpose, but it is preferably from 0.1 parts by mass to 20 parts by mass, more preferably 0.3 parts by mass to 10 parts by mass, based on 100 parts by mass of the acrylic rubber. When the amount of the crosslinking accelerator is less than 0.1 parts by mass, a crosslinked product may have very low tensile strength and exhibit a too large change in elongation and tensile strength after applying heat load. In contrast, when the amount of the crosslinking accelerator is more than 20 parts by mass, the rate of crosslinking at crosslinking may be too rapid, the blooming of the crosslinking accelerator to a surface of a crosslinked product may occur, or a crosslinked product may become too hard.

A method for preparing the acrylic rubber is not particularly limited and may be appropriately selected depending on the intended purpose. For example, it can be prepared by a mixing procedure such as a roll mixing, a Banbury mixing, a screw mixing and a solution mixing.

The mixing order of the components is not particularly limited and may be appropriately selected depending on the intended purpose. For example, components incapable of being easily reacted or decomposed with heating are first mixed thoroughly, and thereafter components capable of being easily reacted or decomposed with heating (for example, a crosslinking agent) are mixed together in a short time at a temperature at which neither their reaction nor decomposition occurs.

The crosslinked product can be obtained by crosslinking the acrylic rubber with heating.

The heating temperature of the acrylic rubber is not particularly limited and may be appropriately selected depending on the intended purpose, but it is preferably from 130° C. to 220° C., more preferably 140° C. to 200° C.

The crosslinking time of the acrylic rubber is not particularly limited and may be appropriately selected depending on the intended purpose, but it is preferably from 30 seconds to 5 hours.

A method for heating the acrylic rubber is not particularly limited and may be appropriately selected depending on the intended purpose. Examples thereof include those which are conventionally used for crosslinking rubber, such as a press heating, a steam heating, an oven heating and a hot-air heating. In order to surely crosslink through to the inside of the crosslinked product, after the crosslinking carried out once, a post-crosslinking may be additionally carried out. The time of the post-crosslinking varies depending on a heating method, a crosslinking temperature and a shape, but it is preferably for 1 hour to 48 hours. The heating method and the heating temperature may be appropriately selected.

The Martens hardness at 10 μm-indentation depth is not particularly limited and may be appropriately selected depending on the intended purpose provided that it is from 0.2 N/mm² to 0.8 N/mm². When the Martens hardness is less than 0.2 N/mm², an acrylic rubber-elastic layer is difficult to be made. When the Martens hardness is more than 0.8 N/mm², image quality in paper having irregularities may be deteriorated. The Martens hardness can be measured with a commercially available microhardness tester such as FISCHER SCOPE HM2000LT manufactured by Fischer Instruments, Co. with the indentation depth being set to 10 μm.

The thickness of the elastic layer is not particularly limited and may be appropriately selected depending on the intended purpose. It is preferably 100 μm to 1,000 μm. When the thickness is less than 100 μm, image quality in paper having irregularities may be deteriorated. When the thickness is more than 1,000 μm, camber angles at the end of a belt may be increased because of high shrinkage force of rubber.

A method for imparting flame retardancy to the acrylic rubber i.e., the rubber-elastic layer is not particularly limited and may be appropriately selected depending on the intended purpose. For example, a known flame retardant agent can be used, but a halogen-containing flame retardant agent can not used due to their high environmental load.

A flame retardant agent which has no environmental load and which is inexpensive is not particularly limited and may be appropriately selected depending on the intended purpose. Examples thereof include known metal hydroxide compounds such as aluminum hydroxide and magnesium hydroxide.

The amount of the flame retardant agent added is required to be 100 parts by mass or more relative to that of rubber in terms of flame retardancy. As a result, the Martens hardness becomes 0.8 N/mm² or more and metal hydroxide compounds can not be used alone. Accordingly, an elastic intermediate transfer belt formed of rubber for use in copiers can be achieved which has a Martens hardness of 0.2 N/mm² to 0.8 N/mm² and flame retardancy of VTM-0 grade according to the UL94VTM burning test by means of using phosphorus compounds in combination with the metal hydroxide compounds which are known to impart flame retardancy. In particular, it is preferred that the amount of the metal hydroxide compounds added is from 20 parts by mass to 80 parts by mass, and the amount of the phosphorus compounds added is from 10 parts by mass to 20 parts by mass relative to 100 parts by mass of rubber. When the amount of the metal hydroxide compounds and the phosphorus compounds are less than the lower limits of the above-mentioned ranges, flame retardancy can not be obtained. On the other hand, when the amount of the metal hydroxide compounds and the phosphorus compounds are more than the upper limits of the above-mentioned ranges, the Martens hardness becomes 0.8 N/mm² or more.

The resistivity should be controlled to a desired level for the intermediate transfer belt by adding electrically conductive agents, because the acrylic rubber has solely high resistivity.

A method for controlling the resistivity is not particularly limited and may be appropriately selected depending on the intended purpose. For example, it can be achieved by adding, for example, carbons and ionic electrically conductive agents, but because rubber hardness is an important element in the present invention, preferable are adding ionic electrically conductive agents which exert their effects even in a small amount and no affect on rubber hardness.

The ionic electrically conductive agents are not particularly limited and may be appropriately selected depending on the intended purpose. Examples thereof include perchorates and ionic liquid.

The amount of the ionic electrically conductive agents added is not particularly limited and may be appropriately selected depending on the intended purpose, but it is preferably from 0.01 parts by mass to 3 parts by mass relative to 100 parts by mass of rubber. When the amount is less than 0.01 parts by mass, the resistivity reducing effect may not be achieved. When the amount is more than 3 parts by mass, the electrically conductive agents may bloom or bleed to a surface of a belt.

The resistance of the elastic layer is not particularly limited and may be appropriately selected depending on the intended purpose. It is preferably 1×10⁸ Ω/square to 1×10¹³ Ω/square in terms of surface resistance, and to 1×10⁷ Ω·cm to 1×10¹² Ω·cm in terms of volume resistance.

### <Particle Layer>

Next, the particle layer will be described.

The particle layer is a layer having a uniform concavo-convex pattern and formed on a surface of the elastic layer by arranging individual spherical resin particles in a plane direction of the elastic layer.

Notably, as understood from the production method described below in Examples, the particle layer in the present application refers to a concavo-convex pattern formed on a surface of the elastic layer by arranging individual spherical resin particles in a plane direction of the elastic layer, and is different from a layer in which particles are simply dispersed.

The material of the spherical resin particles are not particularly limited and may be appropriately selected depending on the intended purpose. Examples thereof include spherical particles containing as a major component resins such as acrylic resins, melamine resins, polyamide resins, polyester resins, silicone resins and fluorine resins; and spherical particles composed of rubber material. Additionally, the surfaces of the spherical particles may be surface-treated with a different material. For example, the surfaces of spherical resin particles composed of rubber material may be coated with a hard resin. Also, the spherical resin particles may be hollow or may be porous. Among the above-mentioned particles, silicone resin fine particles are preferable in that they have lubricity in resins and are capable of imparting abrasion resistance and releasability with respect to toner.

The fine spherical resin particles are not particularly limited and may be appropriately selected depending on the intended purpose. It is preferred that the fine spherical resin particles be particles in the shape of spheres produced by, for example, a polymerization method; the closer the fine spherical resin particles are to true spheres, the better. The volume average particle diameter of the fine spherical resin particles is not particularly limited and may be appropriately selected depending on the intended purpose. It is preferable that the volume average particle diameter of the fine spherical resin particles is from 0.5 μm to 5 μm and that the spherical resin particles be monodispersed with a sharp distribution. When the volume average particle diameter is less than 0.5 μm, the particles may be difficult to be applied uniformly to a surface of an acrylic rubber-elastic layer due to significant aggregation of fine particles with each other. When the volume average particle diameter is greater than 5 μm, a surface of a belt may have large irregularities after applying fine particles, resulting in cleaning failure of toner. The fine spherical resin particles are insulative in many cases, so that if the particle diameter is too large, charge potential from the particles remains, and thereby causing a trouble in which images are disturbed by accumulation of the potential at the time of continuous image printing.

The fine spherical resin particles can easily be uniformly arranged by directly applying particles on the elastic layer and leveling the particles.

The timing of applying the fine spherical resin particles to the surface of the elastic layer is not particularly limited and may be appropriately selected depending on the intended purpose. For example, it can be before or after vulcanizing rubber.

### (Method for Producing Intermediate Transfer Belt)

Next, an example of a method of the present invention for producing a intermediate transfer belt will be described.

### <Production Method of Base Layer>

A method for producing a base layer is described. The method for producing the base layer is not particularly limited and may be appropriately selected depending on the intended purpose. Examples thereof include a method for producing a base layer with the use of a coating liquid containing at least a resin component, i.e., a coating liquid containing the polyimide resin precursor or the polyamide-imide resin precursor.

A base formed of the polyimide resins or the polyamide-imide resins is not particularly limited and may be appropriately selected depending on the intended purpose. For example, a surface of a cylindrical support (mold) can be coated with a base substance containing the polyimide resin or the polyamide-imide resin with the use of a coating method such as a spiral coating using a nozzle or a dispenser, a die coating using a wide die, or a roll coating using an application roller.

The roll coating is now described.

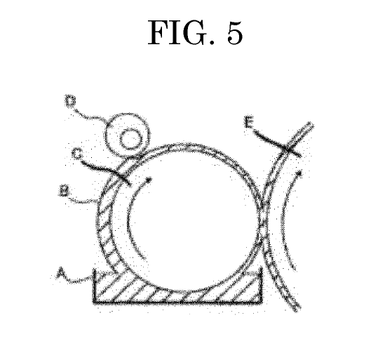

The roll coating method can be performed using a devise shown in FIG. 5. In FIG. 5, reference character “A” denotes a paint pan for storing a degassed precursor liquid (paint), reference character “C” denotes an application roller for continuously drawing the paint up from the paint pan A, reference character “D” denotes a control roller for adjusting the thickness of the paint continuously drawn up from the paint pan A to the predetermined paint thickness between the application roller C and the control roller, and reference character “E” denotes a cylindrical support (metal mold) with which the paint (coating) having the predetermined thickness moves and attaches from the application roller C thereto.

The fully predegassed precursor paint is first poured into the paint pan A in the devise shown in FIG. 5. The viscosity of the paint is not particularly limited and may be appropriately selected depending on the intended purpose, but it has been preferably adjusted to a value between 0.5 Pa·s and 10 Pa·s using a polar organic solvent. The bottom portion of the application roller is then approached toward the paint pan containing the paint and immersed in the paint. The paint is then attached to the surface of the application roller and drawn up by the application roller at a slow peripheral velocity from 10 mm/sec to 100 mm/sec. Subsequently, the thickness of the paint on the surface of the application roller is adjusted by the control roller which is installed above the application roller and capable of adjusting the any gap between the application roller and the control roller. The thickness of the paint B is not particularly limited and may be appropriately selected depending on the intended purpose, but is preferably controlled to be about twice as thick as that of the paint B when transferred to the cylindrical support.

The cylindrical support E, while being slowly rotated, is then approached toward the application roller C by the distance equal to or shorter than the thickness of the paint on the surface of the application roller C. The paint on the surface of the application roller C is transferred from the application roller C to the cylindrical support E rotating in the same direction as the application roller C (“clockwise direction” in FIG. 5). Thus, the paint whose thickness is predetermined is attached to the cylindrical support E.

After the application, with the cylindrical support kept rotating, the solvent in the coating film is evaporated at approximately 80° C. to approximately 150° C. gradually increasing the temperature. In this process, it is preferable to remove vapor including the volatilized solvent in the atmosphere by efficient circulation. When a film with a self-supporting property has been formed, this film and the mold are moved into a heating furnace (firing furnace) capable of high-temperature treatment, then the temperature is increased in steps and high-temperature heating (firing) is performed finally at approximately 250° C. to approximately 450° C. so as to sufficiently make the polyimide resin precursor or the polyamide-imide resin precursor into a polyimide resin or a polyamide-imide resin. Cooling is sufficiently carried out, and then the elastic layer 12 is formed over the base layer.

### <Method for Forming Elastic Layer>

A method for forming an elastic layer will be described.

The method forming the elastic layer is not particularly limited and may be appropriately selected depending on the intended purpose. For example, the elastic layer can be made by applying on the base layer a rubber base paint which contains rubber dissolved in an organic solvent, drying the solvent, and vulcanizing the rubber. The application method is not particularly limited and may be appropriately selected depending on the intended purpose. For example, similar to the base layer, the existing coating method including the spiral coating, the die coating, or the roll coating can be used, but the die coating and the spiral coating which can form a thick coating film are preferable, since the thicker coating is required to form in order to enhance the transferability of a concavo-convex pattern in the surface.

The spiral coating now will be described.

A method of the spiral coating is not particularly limited and may be appropriately selected depending on the intended purpose. For example, a rubber base paint is spirally coated on a base layer by continuously supplying the rubber base paint using a circular or a wide nozzle while moving the nozzle in an axial direction of the base layer and rotating the base layer in a circumferential direction. The rubber base paint spirally coated on the base layer is dried in parallel with leveling by keeping a predetermined rotating speed and a predetermined drying temperature. Subsequently, the paint is vulcanized (crosslinked) and cured at a predetermined vulcanizing temperature to form an elastic layer. The vulcanized elastic layer are then sufficiently cooled, followed by applying fine spherical resin particles (13) to a surface of the elastic layer (12) to obtain a desired seamless belt (intermediate transfer belt).

### <Method for Forming Particle Layer>

A method for forming a particle layer will be described.

The method forming the particle layer is not particularly limited and may be appropriately selected depending on the intended purpose. For example, a powder supplying device 31 and a pushing member 32 are placed as shown in FIG. 4; subsequently, while the cylindrical support 31 is being rotated, spherical resin particles are evenly sprinkled over the surface, then the pushing member 32 is pushed under a constant pressure against the fine spherical resin particles sprinkled over the surface. By means of the pushing member 32, the spherical resin particles 34 are buried in the resin layer while removing the excess the particles. In the present invention, the use of monodisperse spherical resin particles makes it possible to form a uniform, single particle layer by a simple process that only involves the foregoing leveling performed by the pushing member. The burial rate of the fine spherical resin particles is adjusted by altering the pushing time of the pushing member.

### (Image Forming Apparatus)

The seamless belt produced by the above-described method is not particularly limited and may be appropriately selected depending on the intended purpose. For example, the seamless belt can be suitably used as an intermediate transfer belt mounted to a so-called intermediate transfer-based image forming apparatus, in which a plurality of color toner-developed images are sequentially formed on image bearing members, and then primarily transferred onto and sequentially superposed on an intermediate transfer belt, and the resultant primarily-transferred image is secondarily transferred onto a recording medium at one time, to thereby provide an electrophotographic apparatus (image forming apparatus) capable of forming high-quality images. Referring now to the schematic views of essential parts, detail description will next be given to a seamless belt used in the belt constitution section of an image forming apparatus of the present invention. Note that the schematic views are exemplary ones, which should not be construed as limiting the present invention thereto.

FIG. 2 is schematic diagram of a main section for illustrating electrophotographic apparatus including a seamless belt used as a belt member obtained by the production method according to the present invention. As shown in FIG. 2, an intermediate transfer unit 500 including a belt member is composed of, for example, an intermediate transfer belt 501 as an intermediate transfer medium stretched around a plurality of rollers. Around the intermediate transfer belt 501, for example, a secondary transfer bias roller 605 serving as a secondary transfer charge applying unit of a secondary transfer unit 600, a belt cleaning blade 504 as a cleaning unit for the intermediate transfer medium, and a lubricant applying brush 505 as a lubricant applying member of a lubricant applying unit are disposed facing the intermediate transfer belt 501.

A position detecting mark (not shown) is formed on an outer or inner surface of the intermediate transfer belt 501. When the position detecting mark is formed on the outer surface of the intermediate transfer belt 501, it is preferred that the mark be located at a position so as not to come into contact with the cleaning blade 504. When this structure is hard to achieve, the mark may be formed on an inner surface of the intermediate transfer belt 501. An optical sensor 514 serving as a sensor for detecting marks is arranged at a location between a primary transfer bias roller 507 and a belt driving roller 508, which rollers support the intermediate transfer belt 501.

The intermediate transfer belt 501 is stretched around the primary transfer bias roller 507 serving as a primary transfer charge applying unit, the belt driving roller 508, a belt tension roller 509, a secondary transfer opposing roller 510, a cleaning opposing roller 511, and a feedback current detecting roller 512. Each roller is formed of a conductive material, and respective rollers other than the primary transfer bias roller 507 are grounded. A transfer bias is applied to the primary transfer bias roller 507, the transfer bias being controlled at a predetermined level of current or voltage according to the number of superimposed toner images by means of a primary transfer power source 801 controlled at a constant current or a constant voltage.

The intermediate transfer belt 501 is driven in the direction indicated by an arrow by the belt driving roller 508, which is driven to rotate in the direction indicated by an arrow by a driving motor (not shown). The intermediate transfer belt 501 serving as the belt member is generally semiconductive or insulative, and has a single layer or a multi layer structure. In the present invention, a seamless belt is preferably used, so as to improve durability and attain excellent image formation. Moreover, the intermediate transfer belt is larger than the maximum size capable of passing paper so as to superimpose toner images formed on a photoconductor drum 200.

The secondary transfer bias roller 605 is a secondary transfer unit, which is configured to be brought into contact with a portion of the outer surface of the intermediate transfer belt 501, which is stretched around the secondary transfer opposing roller 510 by means of an attaching/detaching mechanism as an attaching/detaching unit described below. The secondary transfer bias roller 605 which is disposed so as to hold a transfer paper P with a portion of the intermediate transfer belt 501 which is stretched around the secondary transfer opposing roller 510, is applied with a transfer bias of a predetermined current by the secondary transfer power source 802 controlled at a constant current.

A pair of registration rollers 610 feeds the transfer paper P as a transfer medium at a predetermined timing in between the secondary transfer bias roller 605 and the intermediate transfer belt 501 stretched around the secondary transfer opposing roller 510. With the secondary transfer bias roller 605, a cleaning blade 608 as a cleaning unit is in contact. The cleaning blade 608 performs cleaning by removing deposition deposited on the surface of the secondary transfer bias roller 605.

In a color copying machine having the above-mentioned construction, when an image formation cycle is started, the photoconductor drum 200 is rotated by a driving motor (not shown) in a counterclockwise direction indicated by an arrow, so as to form Bk (black), C (cyan), M (magenta), and Y (yellow) toner images on the photoconductor drum 200. The intermediate transfer belt 501 is driven in the direction of the arrow by means of the belt driving roller 508.

Along with the rotation of the intermediate transfer belt 501, a formed Bk-toner image, a formed C-toner image, a formed M-toner image, and a formed Y-toner image are primarily transferred by means of a transfer bias based on a voltage applied to the primary transfer bias roller 507. Finally, the images are superimposed on one another in order of Bk, C, M, and Y on the intermediate transfer belt 501, to thereby form a color image.

For example, the Bk toner image is formed as follows.

In FIG. 2, a charger 203 uniformly charges a surface of the photoconductor drum 200 to a predetermined potential with a negative charge by corona discharging. Subsequently, at a timing determined based on signals for detecting marks on the belt, by the use of an optical writing unit (not shown) raster exposure is performed based on a Bk color image signal. When the raster image is exposed, a charge proportional to an amount of light exposure is removed and a Bk latent electrostatic image is thereby formed, in an exposed portion of the photoconductor drum 200 which has been uniformly charged.

Then, by bringing a Bk toner charged to a negative polarity on the Bk developing roller of a Bk developing unit 231K into contact with the Bk latent electrostatic image, the Bk toner does not adhere to a portion where a charge remaining on the photoconductor drum 200, and the Bk toner adsorbs to a portion where there is no charge on the photoconductor drum 200, in other words a portion exposed to the raster light exposure, to thereby form a Bk toner image corresponding to the latent electrostatic image.

The Bk toner image formed on the photoconductor drum 200 is primarily transferred to the outer surface of the intermediate transfer belt 501 being in contact with the photoconductor drum 200, in which the intermediate transfer belt 501 and the photoconductor drum 200 are driven at an equal speed. After primary transfer, slightly remaining toner which has not been transferred from the photoconductor drum 200 to the intermediate transfer belt 501 is cleaned with a photoconductor cleaning unit 201 in preparation for a next image forming operation on the photoconductor drum 200. Next to the Bk image forming process, the operation of the photoconductor drum 200 then proceeds to a C image forming process, in which C image data is read with a color scanner at a predetermined timing, and a C latent electrostatic image is formed on the photoconductor drum 200 by a write operation with laser light based on the C image data.

A revolver development unit 230 is rotated after the rear edge of the Bk latent electrostatic image has passed and before the front edge of the C latent electrostatic image reaches, and the C developing unit 231C is set to a developing position, where the C latent electrostatic image is developed with C toner. From then on, development is continued over the area of the C latent electrostatic image, and at the point of time when the rear edge of the C latent electrostatic image has passed, the revolver development unit rotates in the same manner as the previous case of the Bk developing unit 231K to allow the M developing unit 231M to move to the developing position. This operation is also completed before the front edge of a Y latent electrostatic image reaches the developing position. As for M and Y image forming steps, the operations of scanning respective color image data, the formation of latent electrostatic images, and their development are the same as those of Bk and C, therefore, explanation of the steps is omitted.

Bk, C, M, and Y toner images sequentially formed on the photoconductor drum 200 are sequentially registered in the same plane and primarily transferred onto the intermediate transfer belt 501. Accordingly, the toner image whose four colors at the maximum are superimposed on one another is formed on the intermediate transfer belt 501. The transfer paper P is fed from the paper feed section such as a transfer paper cassette or a manual feeder tray at the time when the image forming operation is started, and waits at the nip of the registration rollers 610. The registration rollers 610 are driven so that the front edge of the transfer paper P along a transfer paper guide plate 601 just meets the front edge of the toner image when the front edge of the toner image on the intermediate transfer belt 501 is about to reach a secondary transfer section where the nip is formed by the secondary transfer bias roller 605 and the intermediate transfer belt 501 stretched around the secondary transfer opposing roller 510, and registration is performed between the transfer paper P and the toner image.

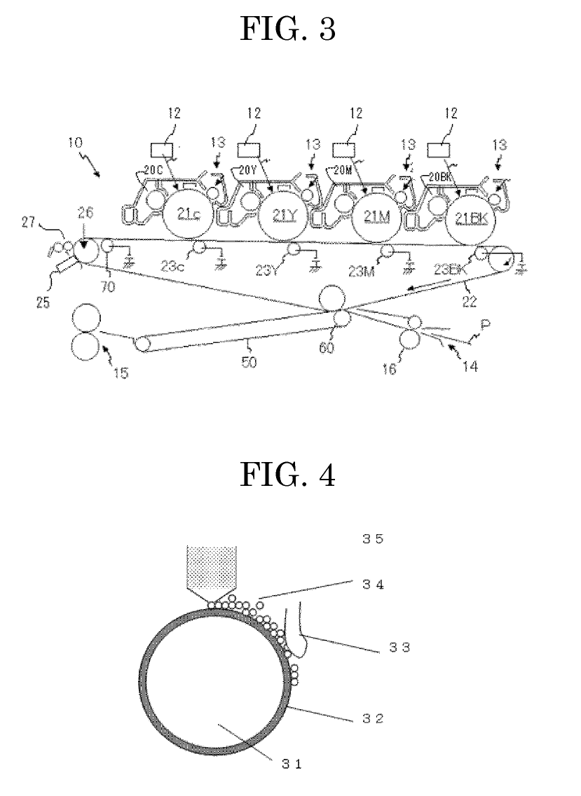

When the transfer paper P passes through the secondary transfer section, the four-color superimposed toner image on the intermediate transfer belt 501 is collectively transferred (secondary transfer) onto the transfer paper P by transfer bias based on the voltage applied to the secondary transfer bias roller 605 by the secondary transfer power source 802. When the transfer paper P passes through a portion facing a transfer paper discharger 606 formed of charge eliminating spines and disposed downstream of the secondary transfer section in a moving direction of a transfer paper guiding plate 601, a charge on the transfer paper sheet is removed and then the transfer paper P is separated from the transfer paper guiding plate 601 to be delivered to a fixing unit 270 via the belt transfer unit 210 which is included in the belt constitution section (see FIG. 3). Furthermore, a toner image is then fused and fixed on the transfer paper P at a nip portion between fixing rollers 271 and 272 of the fixing unit 270, and the transfer paper P is then discharged outside of a main body of the apparatus by a discharging roller (not shown) and is stacked in a copy tray (not shown) with a front side up. The fixing unit 270 may have a belt constitution section.

On the other hand, the surface of the photoconductor drum 200 after the toner images are transferred to the belt is cleaned by the photoconductor cleaning unit 201, and is uniformly discharged by a discharge lamp 202. After the toner image is secondarily transferred to the transfer paper P, the toner remaining on the outer surface of the intermediate transfer belt 501 is cleaned by the belt cleaning blade 504.

The belt cleaning blade 504 is configured to be brought into contact with the outer surface of the intermediate transfer belt 501 at a predetermined timing by the cleaning member attaching/detaching mechanism not shown in the figure.

On an upstream side from the belt cleaning blade 504 with respect to the rotating direction of the intermediate transfer belt 501, a toner sealing member 502 is provided so as to be brought into contact with the outer surface of the intermediate transfer belt 501. The toner sealing member 502 is configured to receive the toner particles scraped off with the belt cleaning blade 504 during cleaning of the remaining toner, so as to prevent the toner particles from being scattered on a conveyance path of the transfer paper P. The toner sealing member 502, together with the belt cleaning blade 504, is brought into contact with the outer surface of the intermediate transfer belt 501 by the cleaning member attaching/detaching mechanism.

To the outer surface of the intermediate transfer belt 501 from which the remaining toner has been removed, a lubricant 506 is applied by scraping it with a lubricant applying brush 505. The lubricant 506 is formed of, for example, zinc stearate in a solid form, and disposed to be brought into contact with the lubricant applying brush 505. The charge remaining on the outer surface of the intermediate transfer belt 501 is removed by discharge bias applied with a belt discharging brush (not shown), which is in contact with the outer surface of the intermediate transfer belt 501. The lubricant applying brush 505 and the belt discharging brush are respectively configured to be brought into contact with the outer surface of the intermediate transfer belt 501 at a predetermined timing by means of an attaching/detaching mechanism (not shown).

When the copying operation is repeated, in order to perform an operation of the color scanner and an image formation onto the photoconductor drum 200, an operation proceeds to an image forming process of a first color (Bk) of a second sheet at a predetermined timing subsequent to an image forming process of the fourth color (Y) of the first sheet. As for the intermediate transfer belt 501, a Bk toner image of the second sheet is primarily transferred to the outer surface of the intermediate transfer belt 501 in an area of which has been cleaned by the belt cleaning blade 504 subsequent to a transfer process of the toner image of four colors on the first sheet of the transfer paper. Then, the same operations are performed for a next sheet as for the first sheet. Operations have been described in a copy mode in which full-color copies of four colors are obtained. The same operations are performed the number of corresponding times for specified colors in copy modes of three or two colors. In a monochrome-color copy mode, only the developing unit of a predetermined color in the revolver development unit 230 is put in a development active state until the copying operation is completed for the predetermined number of sheets, and the belt cleaning blade 504 is kept in contact with the intermediate transfer belt 501 while the copying operation is continuously performed.

In the above-mentioned embodiment, a copier having only one photoconductor drum 1 is described. However, the electrophotographic intermediate transfer belt of the present invention can be used, for example, in a tandem type image forming apparatus illustrated in FIG. 3, in which a plurality of photoconductor drums are serially arranged along an intermediate transfer belt formed in the seamless belt.

Namely, FIG. 3 shows a structural example of a four-drum digital color printer having four photoconductor drums 21Bk, 21Y, 21M, and 21C for forming toner images of four colors (black, yellow, magenta, cyan).

In FIG. 3, a main body of a printer 10 is constituted with image writing sections 12, image forming sections 13, paper feeding sections 14, for electrophotographic color image formation. Based on image signals, image processing operation is performed in an image processing section, and converted to color signals of black (Bk), magenta (M), yellow (Y), and cyan (C), and then color signals are transmitted to the image writing sections 12. The image writing sections 12 are laser scanning optical systems each including a laser light source, a deflector such as a rotary polygon mirror, a scanning imaging optical system, and mirrors, and have four optical writing paths corresponding to color signals, and perform image writing corresponding to respective color signals on image bearing members (photoconductors) 21Bk, 21M, 21Y, 21C provided for respective colors in the image forming sections 13.

The image forming sections 13 includes four photoconductors 21Bk, 21M, 21Y and 21C serving as image bearing member for black (Bk), magenta (M), yellow (Y) and cyan (C), respectively. Generally, organic photoconductors are used as these photoconductors. Around each of the photoconductors 21Bk, 21M, 21Y, 21C, a charging unit, an exposure portion irradiated with laser beam from the image writing section 12, each of developing units 20Bk, 20M, 20Y, 20C, each of primary transfer bias rollers 23Bk, 23M, 23Y, 23C as a primary transfer unit, a cleaning unit (abbreviated), and other devices such as a discharging unit for the photoconductor (not shown) are arranged. Each of the developing units 20Bk, 20M, 20Y, 20C uses a two component magnet brush developing method. An intermediate transfer belt 22, which is the belt constitution section, is located between each of the photoconductors 21Bk, 21M, 21Y, 21C and each of the primary transfer bias rollers 23Bk, 23M, 23Y, 23C. Black (Bk), magenta (M), yellow (Y) and cyan (C) color toner images formed on the photoconductors 21Bk, 21M, 21Y, 21C are sequentially superimposingly transferred to the intermediate transfer belt 22.

The transfer paper P fed from the paper feeding section 14 is fed via a registration roller 16 and then held by a transfer conveyance belt 50 as a belt constitution section. The toner images transferred onto the intermediate transfer belt 22 are secondarily transferred (collectively transferred) to the transfer paper P by a secondary transfer bias roller 60 as a secondary transfer unit at a point in which the intermediate transfer belt 22 is brought into contact with the transfer conveyance belt 50. Thus, a color image is formed on the transfer paper P. The transfer paper P on which the color image is formed is fed to a fixing unit 15 via the transfer conveyance belt 50, and the color image is fixed on the transfer paper P by the fixing unit 15, and then the transfer paper P is discharged from the main body of the printer.

Toner particles remaining on the surface of the intermediate transfer belt 22, which has not been transferred in the secondary transfer process, are removed by a belt cleaning member 25.

On a downstream side from the belt cleaning member 25 with respect to the rotation direction of the intermediate transfer belt 22, a lubricant applying unit 27 is provided. The lubricant applying unit 27 includes a solid lubricant and a conductive brush configured to rub the intermediate transfer belt 22 so as to apply the solid lubricant to the surface of the intermediate transfer belt 22. The conductive brush is constantly in contact with the intermediate transfer belt 22, so as to apply the solid lubricant to the intermediate transfer belt 22. The solid lubricant is effective to improve the cleanability of the intermediate transfer belt 22, thereby preventing occurrence of filming thereon, and improving durability of the intermediate transfer belt 22.

### EXAMPLES

Hereinafter, the present invention will be specifically described based on Examples, which shall not be construed as limiting the scope of the present invention. Various modifications can be made without departing from the scope of the invention.

### [Preparation of Coating Liquid for Base Layer A]

A coating liquid for a base layer was prepared as follows, and was used to produce a base layer of a seamless belt.

First, carbon black (SPECIAL BLACK 4, manufactured by Evonik Degussa) was dispersed in N-methyl-2-pyrrolidone with a bead mill. The resultant dispersion liquid was added to polyimide varnish mainly containing a polyimide resin precursor (U-VARNISH A, manufactured by UBE INDUSTRIES, LTD.) so that the content of the carbon black was adjusted to 17% by mass of the solid content of polyamic acid, followed by thoroughly stirring and mixing, to thereby prepare the coating liquid for the base layer A.

### [Production of Seamless Belt]

Secondly, using as a mold a metal cylindrical support (outer diameter: 340 mm, length: 360 mm) of which outer surface was roughened by blasting, the cylindrical support was installed in the roll coating coater.

The coating liquid for the base layer A was then poured into the paint pan and drawn up with the rotating speed of the application roller at 40 mm/sec. The thickness of the paint on the surface of the application roller was controlled by adjusting the gap between the application roller and the control roller to 0.6 mm. The cylindrical support was then approached toward the application roller while the rotating speed of the cylindrical support was being controlled at 35 mm/sec. The paint on the surface of the application roller was uniformly transferred to the cylindrical support with the gap between the application roller and the cylindrical support at 0.4 mm. After that, while keeping the cylindrical support rotated, heating was carried out for 30 minutes using a hot-air circulation dryer, with the temperature gradually increased to 110° C. With a further increase in temperature to 200° C., heating was carried out for 30 minutes, the rotation was stopped, and then set in a heating furnace (firing furnace) capable of high-temperature treatment, and heat treatment (firing) was carried out for 60 minutes with the temperature increased to 320° C. in steps.

### Example 1

### Production of Elastic Layer Over Base Layer

Firstly, each ingredient was mixed together in a proportion shown in Table 1 and then kneaded to produce a rubber composition.

TABLE 1

| | Example | | |
|---|---|---|---|
| | 1 | 2 | 3 |
| Acrylic rubber | 100 | 100 | 100 |
| Stearic acid | 1 | 1 | 1 |
| Red phosphorus | 10 | 20 | 20 |
| Aluminum hydroxide | 60 | 50 | 70 |
| Closslinking agent | 0.6 | 0.6 | 0.6 |
| Crosslinking accelerator | 1 | 1 | 1 |
| Electrically conductive agent | 0.3 | 0.3 | 0.3 |

Acrylic rubber: NIPOL AR12 (manufactured by ZEON CORPORATION)
Stearic acid: STEARIC ACID CAMELLIA BEAD (manufactured by NOF CORPORATION)
Red phosphorus: RINKA FE 140F (manufactured by RINKAGAKU KOGYO CO., LTD.)
Aluminum hydroxide: HIGILITE H42M (manufactured by Showa Denko K.K.)
Closslinking agent: DIAK No. 1 (hexamethylenediaminecarbamate; manufactured by DuPont Performance Elastomers L.L.C.)
Crosslinking accelerator: VULCOFAC ACT55 (70% a salt of 1,8-diazabicyclo (5,4,0) undecene-7 and a dibasic acid, 30% amorphous silica; manufactured by Safic-Alcan)
Electrically conductive agent: QAP-01 (tetrabutylammonium perchlorate; manufactured by Japan Carlit Co., Ltd.)

The rubber composition prepared as described above was dissolved in an organic solvent (MIBK: methyl isobutyl ketone) to form a rubber solution containing a solid content of 35 percent by mass. This rubber solution was spirally coated on the polyimide base layer by continuously supplying the rubber solution using a nozzle while moving the nozzle in an axial direction of the cylindrical support and rotating in a circumferential direction the cylindrical support on which the polyimide base layer previously formed. The coating amount was set so that the final layer thickness was adjusted to 500 μm. After that, the cylindrical support coated with the rubber solution was placed in a hot-air circulation dryer while the cylindrical support being rotated, and then heated for 30 minutes with the temperature being increased to 90° C. at a temperature increase rate of 4° C./min. Then, continuously, the cylindrical support was heated for 60 minutes with the temperature increased to 170° C. at a temperature increase rate of 4° C./min.

### Example 2

A seamless belt was produced in the same manner as in Example 1, except that each ingredient for forming an elastic layer laid over a base layer was mixed together in a proportion shown in Table 1 and kneaded.

### Example 3

A seamless belt was produced in the same manner as in Example 1, except that each ingredient for forming an elastic layer laid over a base layer was mixed together in a proportion shown in Table 1 and kneaded.

### Comparative Example 1

A seamless belt of Comparative Example 1 was produced in the same manner as in Example 1, except that a formulation shown in Table 2 was used instead of a formulation of acrylic rubber according to Examples 1 to 3 shown in Table 1.

TABLE 2

| | Comparative | | |
|---|---|---|---|
| | Example | | |
| | 1 | 2 | 3 |
| Acrylic rubber | 100 | 100 | 100 |
| Stearic acid | 1 | 1 | 1 |
| Aluminum hydroxide | 150 | 100 | — |
| Zinc borate | — | 20 | — |
| Flame retardant agent | — | — | 100 |
| Melamine-based Closslinking agent | 0.6 | 0.6 | 0.6 |
| Crosslinking accelerator | 1 | 1 | 1 |
| Electrically conductive agent | 0.3 | 0.3 | 0.3 |

Zinc borate: ALCANEX XF-100C (manufactured by Mizusawa Industrial Chemicals, Ltd.)
Melamine-based Closslinking agent: MELAPUR MC25 (manufactured by BASF Japan Ltd.)

### Comparative Example 2

A seamless belt of Comparative Example 2 was produced in the same manner as in Example 1, except that a formulation shown in Table 2 was used instead of a formulation of acrylic rubber according to Examples 1 to 3 shown in Table 1.

### Comparative Example 3

A seamless belt of Comparative Example 3 was produced in the same manner as in Example 1, except that a formulation shown in Table 2 was used instead of a formulation of acrylic rubber according to Examples 1 to 3 shown in Table 1.

### Comparative Example 4

A seamless belt of Comparative Example 4 was produced in the same manner as in Example 1, except that a formulation shown in Table 3 was used instead of a formulation of acrylic rubber according to Examples 1 to 3 shown in Table 1.

TABLE 3

| | | | | | | Red |
|---|---|---|---|---|---|---|
| Nitrile | Stearic | Zinc | | Vulcanizing | Aluminum | phos- |
| rubber | acid | oxide | Sulfur | accelerator | hydroxide | phorus |
| 100 | 1 | 5 | 1 | 0.5 | 60 | 20 |

Nitrile rubber: NIPOL DN2850 (manufactured by ZEON corporation)
Vulcanizing accelerator: NOCCELER TS (tetramethylthiuram mono-sulfide, manufactured by OUCHI SHINKO CHEMICAL INDUSTRIAL CO., LTD.)

### Comparative Example 5

A seamless belt of Comparative Example 5 was produced in the same manner as in Example 1, except that a formulation shown in Table 4 was used instead of a formulation of acrylic rubber according to Examples 1 to 3 shown in Table 1.

TABLE 4

| Hydro- | | | | | | |
|---|---|---|---|---|---|---|
| genated | | | | | | Red |
| nitrile | Stearic | Zinc | | Vulcanizing | Aluminum | phos- |
| rubber | acid | oxide | Sulfur | accelerator | hydroxide | phorus |
| 100 | 1 | 5 | 1 | 0.5 | 60 | 20 |

Hydrogenated nitrile rubber: ZETPOL 2020L (manufactured by ZEON corporation)
Vulcanizing accelerator: NOCCELER TS (tetramethylthiuram mono-sulfide, manufactured by OUCHI SHINKO CHEMICAL INDUSTRIAL CO., LTD.)

### Comparative Example 6

The acrylic rubber-elastic layer according to Examples 1 to 3 based on the formulation shown in Table 1 changed to polyurethane robber elastic layer.

To 100 parts by mass of RUP-1627 (block type isocyanate), i.e., base resin for urethane resin (URE-HYPER) manufactured by DIC corporation, were added 70 parts by mass of aluminum hydroxide and 20 parts by mass of red phosphorus described in Example sections, then 20 parts by mass of DMF (dimethylformamide) as a solvent for modifying velocity. The resulting mixture was thoroughly stirred to disperse the additives. Ten parts by mass of a curing agent CLH-5 (amine curing agent) was then added, stirred, and mixed to prepare a coating liquid for urethane rubber. This coating liquid was spirally coated on a polyimide base layer by continuously supplying the coating liquid using a nozzle while moving the nozzle in an axial direction of a cylindrical support and rotating in a circumferential direction the cylindrical support on which the polyimide base layer previously formed. The coating amount was set so that the final layer thickness was adjusted to 500 μm. After that, a metal mold was placed in a hot-air circulation dryer while the metal mold being rotated, and then heated for 60 minutes with the temperature being increased to 150° C. at a temperature increase rate of 4° C./min.

### [Production of Particle Layer Over Elastic Layer]

Each elastic layer of Examples 1 to 3 and Comparative Examples 1 to 6 was thoroughly cooled, and then a particle layer was formed over the elastic layer. Silicone spherical particles (TOSPEARL 120 (volume average particle diameter: 2.0 μm); manufactured by Momentive Performance Materials Inc.) as spherical particles were evenly sprinkled over the surface in a manner shown in FIG. 4. Then, a pushing member of a polyurethane rubber blade was pushed against the spherical particles to fix the spherical particles to the elastic layer. The resultant laminate was then separated from a metal mold thereby forming respective intermediate transfer belts.

The following properties were evaluated using the above-mentioned intermediate transfer belts.

Martens hardness: The Martens hardness at 10 μm-indentation depth was measured with a microhardness tester (HM2000LT, manufactured by Fischer Instruments, Co.) at 10 μm-indentation depth.

Flame retardancy: A test piece used was a laminate in which an elastic layer was laminated over a polyimide base layer (no silicone spherical resin particle was applied). The measurement was performed in accordance with JIS K7341.

Ozone resistance: A test piece being coiled around a cylindrical rod (2 mm in diameter) was left in a box with an ozone concentration of 5 ppm for 5 days at 20° C. and 50% RH. Then, the presence of cracks on the surface of the belt was evaluated.

Image quality rank in paper having irregularities: The different intermediate transfer belts produced above were mounted in an electrophotographic apparatus shown in FIG. 3, and image quality in paper having irregularities (LEATHAC, 175 kg paper) (i.e., toner transferability in a blue solid printing using two colors of ink, cyan and magenta inks) was visually observed and ranked on a scale of 1 (solid image had irregularities in a concave portion) to 5 (smooth solid image was obtained in a concave portion).

The results are shown in Tables 5-1 and 5-2.

TABLE 5-1

Example

| | 1 | 2 | 3 |
|---|---|---|---|
| Martens hardness (N/mm²) | 0.31 | 0.38 | 0.57 |
| Flame retardancy | VTM-0 | VTM-0 | VTM-0 |
| Ozone resistance | good | good | good |
| Image quality rank in paper | 5 | 5 | 4 |
| having irregularities | | | |

TABLE 5-2

| | Comparative Example | | | | | |
|---|---|---|---|---|---|---|
| | 1 | 2 | 3 | 4 | 5 | 6 |
| Martens hardness | 1.41 | 1.31 | 1.12 | 1.51 | 1.65 | 1.15 |
| (N/mm²) | | | | | | |
| Flame retardancy | VTM-0 | NG | NG | VTM-0 | VTM-0 | VTM-1 |
| Ozone resistance | good | good | good | poor | good | poor |
| Image quality rank | 2 | 2 | 3 | 2 | 2 | 3 |
| in paper having | | | | | | |
| irregularities | | | | | | |

It has been found from above results that the present invention can provide an intermediate transfer member which has excellent image quality in paper having irregularities, as well as ozone resistance and flame retardancy.

This application claims priority to Japanese application No. 2011-054057, filed on Mar. 11, 2011, and incorporated herein by reference.

What is claimed is:

1. An intermediate transfer belt comprising:
a base layer; and
an elastic layer,
the elastic layer being laid on the base layer to form a laminated structure,
wherein the elastic layer is an acrylic rubber-elastic layer with flame retardancy where the acrylic rubber-elastic layer has VTM-0 grade according to the UL94VTM burning test,
wherein the elastic layer has a Martens hardness of 0.2 N/mm² to 0.8 N/mm² when indented to a depth of 10 μm,
wherein the elastic layer has a uniform concavo-convex pattern in a surface thereof, and the uniform concavo-convex pattern is formed by arranging individual spherical resin particles in the surface of the elastic layer in a plane direction thereof, and
wherein the intermediate transfer belt is configured to receive a toner image formed by developing, with a toner, a latent image on an image bearing member.

2. The intermediate transfer belt according to claim 1, wherein the acrylic rubber-elastic layer with flame retardancy contains a metal hydroxide compound and a phosphorus compound.

3. The intermediate transfer belt according to claim 1, wherein the spherical resin particles are fine silicone resin particles.

4. The intermediate transfer belt according to claim 1, wherein the spherical resin particles have a volume average particle diameter of 0.5 μM to 5 μm.

5. The intermediate transfer belt according to claim 1, wherein the base layer contains at least one of a polyimide resin and a polyamideimide resin.

6. An image forming apparatus comprising:
an image bearing member configured to form a latent image thereon and bear a toner image;
a developing unit configured to develop with a toner the latent image formed on the image bearing member to form the toner image;
an intermediate transfer belt onto which the toner image developed with the developing unit is primarily transferred; and
a transfer unit configured to secondarily transfer onto a recording medium the toner image transferred onto the intermediate transfer member;
wherein the intermediate transfer belt comprises:
a base layer; and
an elastic layer,
the elastic layer being laid on the base layer to form a laminated structure,
wherein the elastic layer is an acrylic rubber-elastic layer with flame retardancy where the acrylic rubber-elastic layer has VTM-0 grade according to the UL94VTM burning test,
wherein the elastic layer has a Martens hardness of 0.2 N/mm² to 0.8 N/mm² when indented to a depth of 10 μm,
wherein the elastic layer has a uniform concavo-convex pattern in a surface thereof, and the uniform concavo-convex pattern is formed by arranging individual spherical resin particles in the surface of the elastic layer in a plane direction thereof, and
wherein the intermediate transfer belt is configured to receive the toner image formed by developing, with the toner, the latent image on the image bearing member.

7. The image forming apparatus according to claim 6, wherein the image forming apparatus is a full-color image forming apparatus where a plurality of the image bearing members each having the developing unit for each color are arranged in series.
